(19) United States
(12) Patent Application Publication
(10) Pub. No.: US 2009/0020705 A1
(43) Pub. Date: Jan. 22, 2009

(54) Fiber Optic Enhanced Scintillator Detector

(76) Inventor: Kiril A. PANDELISEV, Mesa, AZ (US)

Correspondence Address: CERMAK KENEALY & VAIDYA, LLP, 515 EAST BRADDOCK RD SUITE B, Alexandria, VA, 22314, US

(21) Appl. No.: 12/177,136

(22) Filed: Jul. 21, 2008

Related U.S. Application Data
(62) Division of application No. 09/881,104, filed on Jun. 15, 2001, now abandoned.
(60) Provisional application No. 60/270,904, filed on Feb. 26, 2001.

(51) Int. Cl. G01T 1/20

(52) U.S. Cl. 250/370.11

(57) ABSTRACT

The new scintillators are connected at one or more points or on one or more sides or faces, or on any or all sides to conductors which are collimators, lenses or fiber ends. Optical fibers in cables conduct the photons generated by the crystal scintillators to photon-actuated devices. The devices may be mounted near the crystal scintillators or remote from the crystal scintillators, for example on surfaces near drilled wells or exploration holes. The crystals or scintillators have any of several cross-sections. Down hole detectors or detectors used in other adverse conditions are ruggedized, with rugged flexible outer cases which are transparent to the looked-for energy, particles or rays, gamma rays for example. Inner scintillator construction of multiple aligned or angularly related scintillators connected to optical fiber ends allow bending, twisting and flexing without damaging scintillator arrays, individual scintillators, lenses or fiber optic connections. Optical fibers are connected to optical couplers on gamma camera plate scintillators to transmit patterns of photons through optical fiber cables to remote reading, storing or detecting sites. Illumination of remote sites is provided by fibers that parallel the photon conducting fibers. One or more optical fibers illuminates the site being studied by the scintillator, and one or more optical fibers return images of the site to a viewer screen or recorder.

This application claims the benefit of U.S. Provisional Application No. 60/270,904, filed Feb. 26, 2001.

### BACKGROUND OF THE INVENTION

Scintillator detectors are used in a wide range of environments for detecting events and rays, particularly gamma rays. In down hole detectors, for example detections of gamma rays are used to determine geologic structures. Gamma camera plates are used in medical applications, for imaging and inspecting and anywhere that Computer Aided Tomography (CAT) scans are used.

Needs exist for improved scintillator detectors.

### SUMMARY OF THE INVENTION

New scintillation detectors provided crystals or other scintillators with one or more optical fibers to conduct photons to photoactive devices such as, for example, photodiodes, photomultiplier tubes or other photon reactive devices. Photons are conducted to the detectors or photoactive devices through lenses, micro lenses and/or through collimators.

One preferred form of the crystal scintillator uses optical fibers and micro lenses to direct photons to the photoactive devices.

The scintillators, which preferably are doped crystals, produce the photons upon being energized by particles, energy or rays, especially gamma rays. The new scintillators are connected at one or more points or on one or more sides or faces, or on any or all sides to conductors which are collimators, lenses or fiber ends. Optical fibers in cables conduct the photons generated by the crystal scintillators to photon-actuated devices. The devices may be mounted near the crystal scintillators or remote from the crystal scintillators, for example on surfaces near drilled wells or exploration holes. The crystals or scintillators have any of several cross-sections. Down hole detectors or detectors used in other adverse conditions are ruggedized, with rugged flexible outer cases which are transparent to the looked-for energy, particles or rays, gamma rays for example. Inner scintillator construction allows bending, twisting and flexing without damaging scintillator arrays, individual scintillators, lenses or fiber optic connections.

In one preferred form of the invention, a plurality of smaller crystals or scintillators are connected with optical fibers in cables to photon-activated devices. Preferably a plurality of the smaller crystals or scintillators is connected with optical fibers to one photon-active device, for example a photodiode, photomultiplier, or other photon-receiving device. Each crystal or scintillator delivers an optical signal to the same one or more photosensors. If one of the smaller crystals or scintillators is cracked or scratched or is otherwise rendered defective, such as by rough handling, the entire signal of the scintillator array is not greatly diminished.

By dividing the crystal or scintillator into a plurality of smaller crystals, the likelihood of cracking or injuring the crystals is reduced. The array is flexible and is capable of bending, twisting and absorbing shock, such as encountered in down hole operations, for example.

The structural package of the smaller crystals may include from a few crystals up to many crystals, for example five or fewer crystals to fifty crystals, or more.

The small crystals in the array may be constructed in any cross-sectional configuration and may be packed, for example, in a stacked array of sloped crystals within a tubular sheet to provide flexing, impact-absorbing, bending and twisting in response to external impacts and without damaging the array, individual crystals within the array or optical fiber connections to the crystals.

The plurality of smaller crystals are arranged in arrays, such that the entire detector is flexible in its longitudinal axis, and also such that the entire array twists without affecting the results and without damaging the individual smaller crystals and optical fiber connectors.

Each small crystal is an optically optimized scintillator in itself.

Each small crystal may be coupled to an optical fiber output at one surface or more than one surface.

Optical fibers may be made of optical scintillator materials which strengthen the signals moving through the optical fibers, increasing light energy while transmitting the input photons.

One preferred form of the invention uses gamma camera plates coupled to fibers through micro lens arrays.

In preferred embodiments optical fibers connected to the scintillators are bundled with remote object illuminators and image viewing fibers for viewing insides of wells and bores, patients or welds being inspected.

In one embodiment, the scintillation crystals are individually isolated detectors. The crystals can be connected by an elastomer. Preferably the crystals/detectors are interconnected by an optically transparent or translucent elastomer and then are connected to a fiber optic cable or to a fiber optic cable bundle.

In one embodiment, the scintillation crystal assembly has an optical viewing portion that allows the operator to view the assembly and other parts from a distance. The optical viewing portion has light sources at one or both ends and employs micro lenses, lenses, shaped light guides, and other optical components to provide for sharp images of the parts being viewed. The viewing is for observation purposes or for shape and size measurement purposes, and for purposes of certain control functions to be performed.

Well logging devices have scintillation measurement and optical measurement capabilities using this approach. The image the data are analyzed at distance, or they are converted into other signals and transmitted with or without signal transmission lines.

Using the coupled viewing system in gamma camera device applications, a user remotely views the patient being examined in real time, or the image signal is recorded while the gamma ray examination takes place.

Remote gamma ray or other high energy rays or particle measuring tools having optical viewing capabilities use this combined tool. Weld inspection units are capable of examination of the weld quality and visual inspection before, during and after the tests.

Remote gamma ray, X-ray, high energy particle tools having visual inspection are used in radioactive storage tank applications, automotive industry applications, and other industrial tools for measurement of high energy rays or particles, or measurements using such high energy rays or particles for structural integrity, density, uniformity and similar applications.

Combinations of light sources, X-ray sources, X-ray detectors and visual inspection capabilities are included.

These and further and other objects and features of the invention are apparent in the disclosure, which includes the above and ongoing written specification, with the claims and the drawings.

### BRIEF DESCRIPTION OF THE DRAWINGS

FIG. 1 shows a scintillator with multiple optical fiber connections.

FIG. 2 shows a similar scintillator with an optical coupler having a micro-lens array.

FIG. 3 is a schematic representation of a scintillator with an optical coupler and micro-lens array, an optical fiber cable and a photomultiplier tube with a thermal electric cooler and magnetic field shielding.

FIG. 4 is a schematic representation similar to FIG. 3, with an optical collimator and a magnetic shield and thermal electric cooler added to a photomultiplier tube and to a preamplifier.

FIG. 5 is a schematic representation of an array of smaller optically optimized scintillators coupled to a photodetector with optical fibers in a cable. The photodetector is a photomultiplier tube, a photodiode or other photon detecting device. The photodetector is connected to each scintillator with a single or multiple optical fibers. A magnetic shield and a thermal electric cooler surround the photosensor.

FIG. 6 is a schematic representation of a single small optically optimized scintillator with optical coupling to optical fibers from the top, from one or more sides, or from a bottom and a side.

FIG. 7 shows several preferred cross-sections of the smaller optically optimized scintillators.

FIG. 8 shows an embodiment of a plurality of smaller scintillators coupled with optical fibers to a remote photosensitive device. The scintillators are arranged in an array which provides linear flexibility and twistability of the array without damaging the individual scintillators.

FIG. 9 shows a remote photosensor connected to the optical fibers in the cable.

FIG. 10 shows representative cross-sections of small optically optimized scintillators.

FIG. 11 is a schematic cross-section of an array of scintillators packaged with two photomultiplier tube detectors and related preamplifiers in a rugged flexible case.

FIG. 12 shows a gamma ray detector plate assembly using single or multiple optical fibers in a cable for conducting photons generated within the scintillator to detectors.

FIG. 13 is a segmented top view of a gamma ray detector plate assembly.

FIG. 14 is a partial cross-sectional view of the assembly shown in FIG. 13.

FIG. 15 is a partial top view detail of a fiber optic assembly connected to a single plate gamma ray detector.

FIG. 16 is a schematic representation of multiple individual detectors, optical fibers, a light source and an optical fiber or bundle of optical fibers for remote image viewing.

FIG. 17 is a schematic representation of apparatus for visually inspecting welds concurrently with X-ray scintillation inspection.

FIG. 18 is a schematic representation of apparatus for visually inspecting an area of a patient concurrently with using a gamma camera plate assembly.

### DETAILED DESCRIPTION OF THE PREFERRED EMBODIMENTS

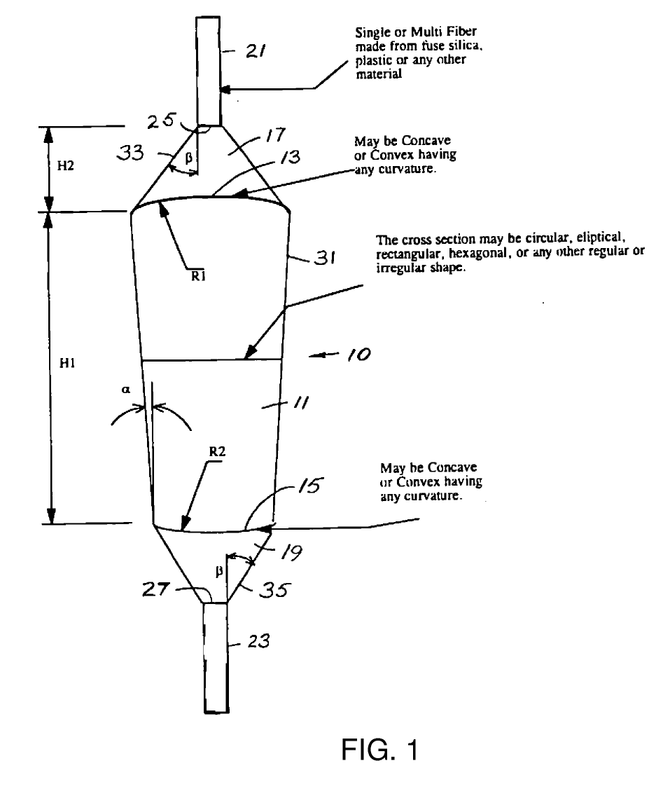

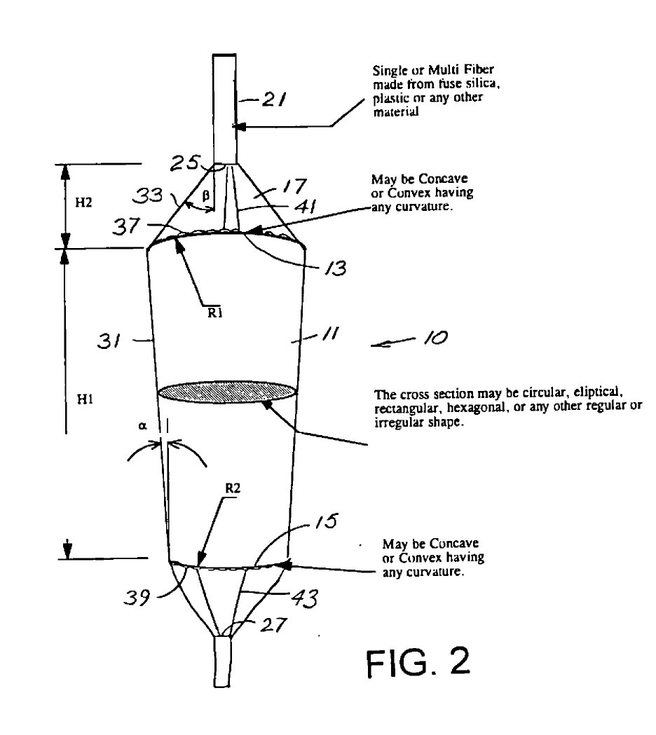

Referring to FIGS. 1 and 2, a scintillator detector 10 has a body 11. In the example, a generally truncated conical body with a sidewall angle alpha assists in directing the photons generated by internal scintillations toward the spheroidal lens-like ends 13 and 15 of the body 11. The concave or convex shaped lens surface ends 13 and 15 cooperate with the collimators 17 and 19. The collimators direct the photons generated in the scintillator 10 to single or multiple optical fibers 21 and 23. The single or multiple optical fibers are made from quartz or any other material which conducts the light energy which is directed into the ends 25 and 27 of the fibers. The photons generated within scintillator body 11 are directed to the ends 25 and 27 of the optical fibers. The sloped wall 31 of the scintillator body 11 reflects the photons out of the ends or back into the scintillator. The curved end walls 13 and 15 refract the photons. The sloped walls 33 and 35 of the collimators 17 and 19 reflect the photons toward the ends 25 and 27 of the optical fibers 21 and 23.

The length of the fibers can be long and can control dark current related problems. Low attenuation fibers connect scintillators in wells and test holes deep below the surface to photon-activated devices, such as photomultiplier tubes, on the surface.

The cross-section of the scintillator body 11 may be circular, elliptical, rectangular, hexagonal or any other regular or irregular shape. The angle alpha of the walls 31 of the scintillator body 11 are any angles between −180° and 180°. The angles beta of the collimator walls 33 and 35 are angles between −180° and 180°. The radii R1 and R2 of the optical coupler surfaces 13 and 15 have any concave or convex curvature which promotes the transmission and refraction of photons to direct the impingement of the photons on ends 25 and 27 of the single or multiple optical fibers 21.

The optical couplers 33 and 35 preferably are made of optically transparent elastomers to focus the electrons, while cushioning vibrations in ruggedized structures, for example in down hole oil well logging applications.

As shown in FIG. 2, the optical couplers 13 and 15 may be formed with micro lenses 37 and 39, which reflect and focus the photons from scintillator body 11 to the ends 25 and 27 of the single or multiple optical fibers. Alternatively, the individual lenses 37 and 39 are connected to one or more individual fibers 41 and 43 which are ends of the multiple fibers 21 and 23. In that case, the individual fibers extend from the ends 25 and 27 to the individual multiple micro lenses 37 and 39 in the arrays which form the curved optical couplers 13 and 17 on the longitudinal ends of the scintillator body 11.

As shown in FIGS. 1 and 2, the single or multiple fibers 21 and 23 may be connected to the inputs of a single photon-activated device, such as a photomultiplier tube. The fibers 21 and 23 may be connected to multiple photon-activated devices. The former is preferred as a way to save costs and to promote compactness of the equipment.

The axial lengths H1 and H2 of the scintillator body 10 and the collimator 17 are coordinated to focus protons from the scintillator body 11 to the end 25 of the single or multiple optical fiber 21. Preferably H1 is greater than H2 to provide the maximum scintillator dimensions within a fixed overall length.

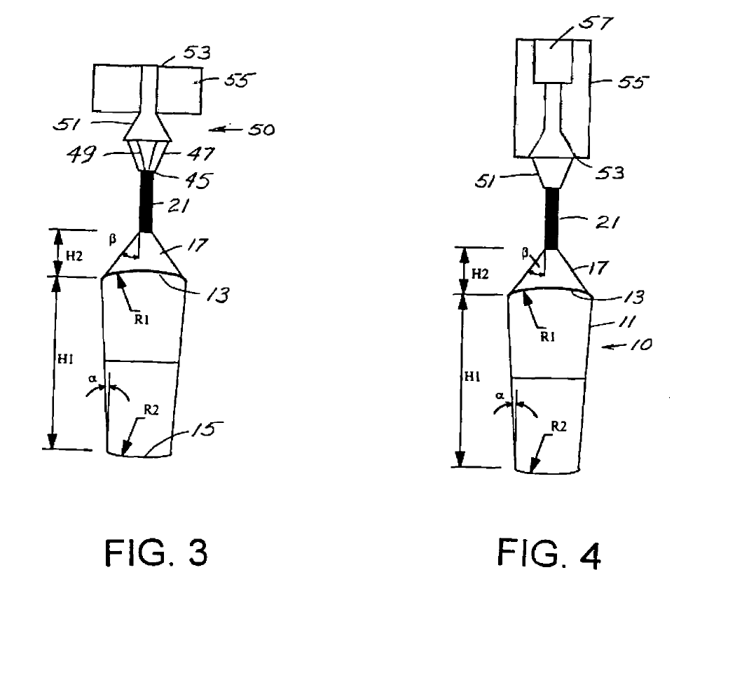

Referring to FIG. 3, a scintillator 10 has a body 11. A curved optical coupler end 13 may have a micro lens array. A collimator 17 may be a clear elastomeric body or an expansion of the optical fibers 21.

The single or multiple optical fibers 21 have at the second end 45 a solid transparent piece 47, preferably of an elastomeric transparent material, or a fiber geometry 49, which connects the single or multiple fibers 21 to a photo-active device 50 such as a photomultiplier tube 51. The photomultiplier tube is surrounded by a thermal electric cooler 53 and a magnetic shield 55. The magnetic shield 55 and the thermal electric cooler, which may be a Peltier cooler, reduce unwanted dark currents. The use of small dynodes within the photomultipliers operate to lower or eliminate dark currents within the photomultiplier which interfere with the precise output of the photomultiplier tubes.

In FIG. 4 the thermal electric cooler 53 and the magnetic shield 55 surround the preamplifier 57, as well as the entire photomultiplier tube 51.

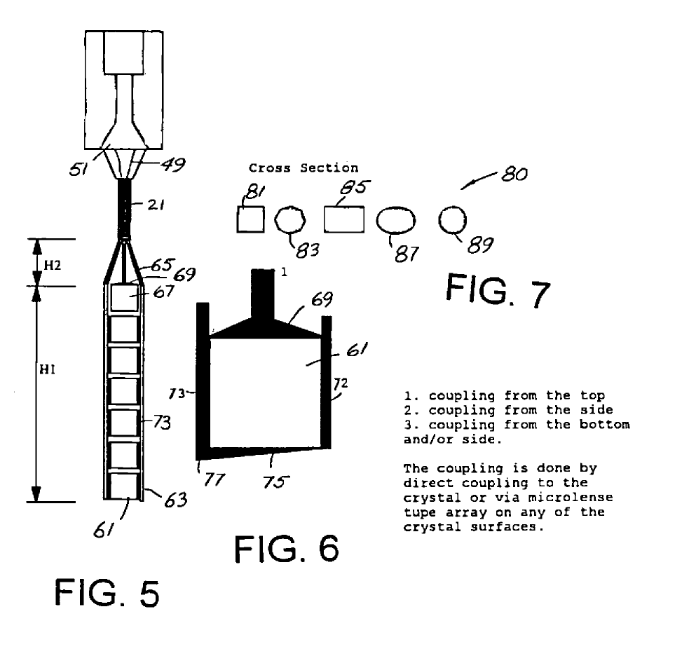

Referring to FIG. 5, an array 60 of a plurality of optically optimized scintillators 61 is mounted within a gamma ray-transparent flexible ruggedized case 63. Each scintillator 61 has one or more optical fibers 65 connected to the multiple optical fiber 21. The upper scintillator 67 is connected with a coupling 69 at the top. Lower scintillators 71 are connected with couplings 73 at the sides. Each scintillator 61 within the array preferably is directly coupled to the photomultiplier 51 through the fibers which extend directly to the input of the photomultiplier. The photomultiplier may be any photodetector, such as a diode or other photo-reactive device. Each scintillator may be connected to single or multiple optical fibers.

As shown in FIG. 6, the coupling may be a coupling 69 from the top of the scintillator 61, or a coupling 73 or 72 from either or both sides of the scintillator 61, a coupling 75 from the bottom of a scintillator device, or a coupling 77 from one side and the bottom of the scintillator device. Each scintillator has a cross-section which is selected from any conceivable cross-section.

Some of the preferred cross-sections 80 are shown in FIG. 7, for example square cross-section 81, polygonal cross-section 83, rectangular cross-section 85, elliptical cross-section 87 and circular cross-section 89. Any of these cross-sections or combinations of the cross-sections is suitable for the scintillators 61.

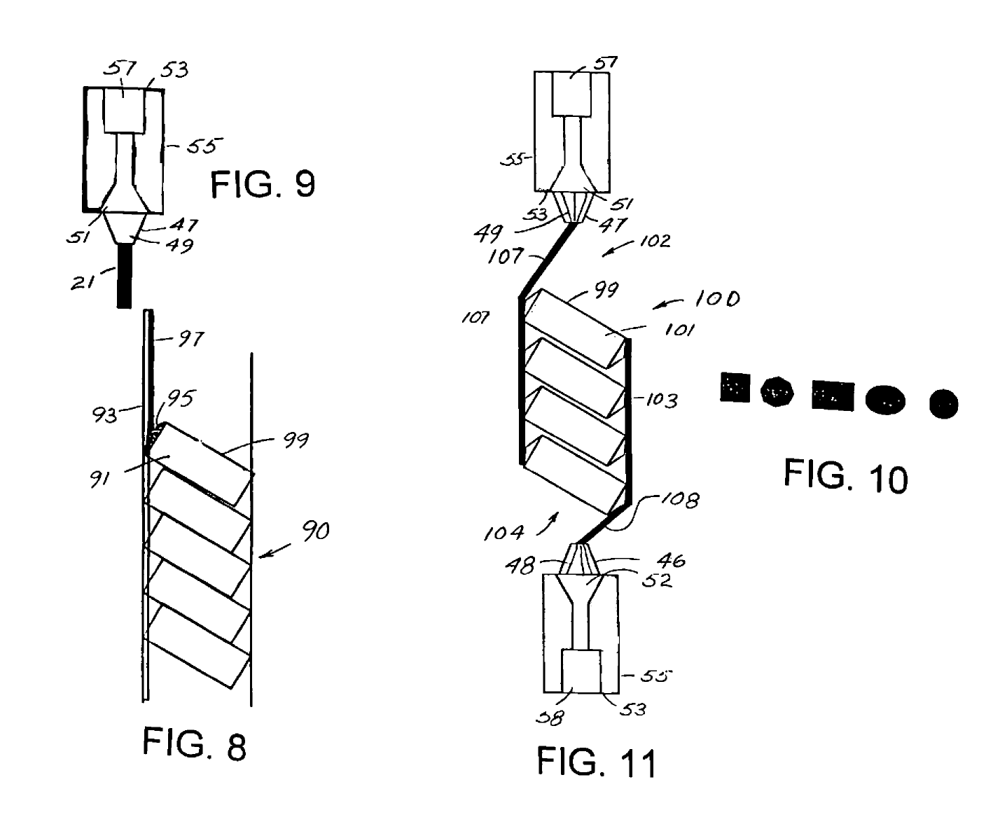

As shown in FIGS. 8, 9 and 10, an array 90 of optically optimized, scintillators 91 is shown in an overlying sloped arrangement arranged axially within a gamma ray transparent ruggedized tube 93. Each scintillator 91 has an end optical coupler 95 which is connected to one or more optical fibers 97 to connect the individual scintillators 91 to the single or plurality of optical fibers 21, and thence through the connectors 47 or 49 to the photodetector. Photomultiplier tube 51, with preamplifier 57, is cooled 53 and screened 55 to reduce or avoid dark currents.

Each of the plurality of independent scintillators is coupled with one or more optical sensors embodied in an oil well logging, logging-while-drilling, or other configuration where the scintillator sensitivity, accuracy and viability are required, and the working conditions are rough and can cause sensor damage and inherent signal degradation in less rugged sensors. The combined scintillators are made to be flexible. Flexible plastic scintillators may be used as crystal encasements 99.

Coupling scintillators with the fiber optic cable provide needed X and Y coordinates of the signal and simplify supporting electronics in such devices as, for example, gamma camera applications. Micro lens endings of the fibers dramatically reduce the number of fibers employed while preserving and enhancing the transmission of photons.

Referring to FIG. 11, a scintillator array 100 includes a number of independent scintillators 101 held within a ruggedized sheath 103. Each scintillator has opposite ends 102 and 104. Collimators 105 and 106 at the opposite ends communicate respectively with multiple optical fibers 107 and 108 to move photons from the scintillators 101 through the ends into the optical fibers 107 and 108, and from those respective fibers through guides 46 and 47 and fibers 48 and 49 into the photomultiplier tubes 51 and 52.

The photomultiplier tubes and their respective preamplifiers 57 and 58 are mounted within the electrothermal shields 53. Direct current power, such as from batteries, is supplied to the electrothermal shields 53 to cool the photomultipliers and preamplifiers and to prevent or reduce dark currents generated autonomously within the photomultipliers.

Radio frequency and magnetic field shields 55 surround the photomultipliers 51 and 52 and the preamplifiers 57 and 58 to prevent false readings.

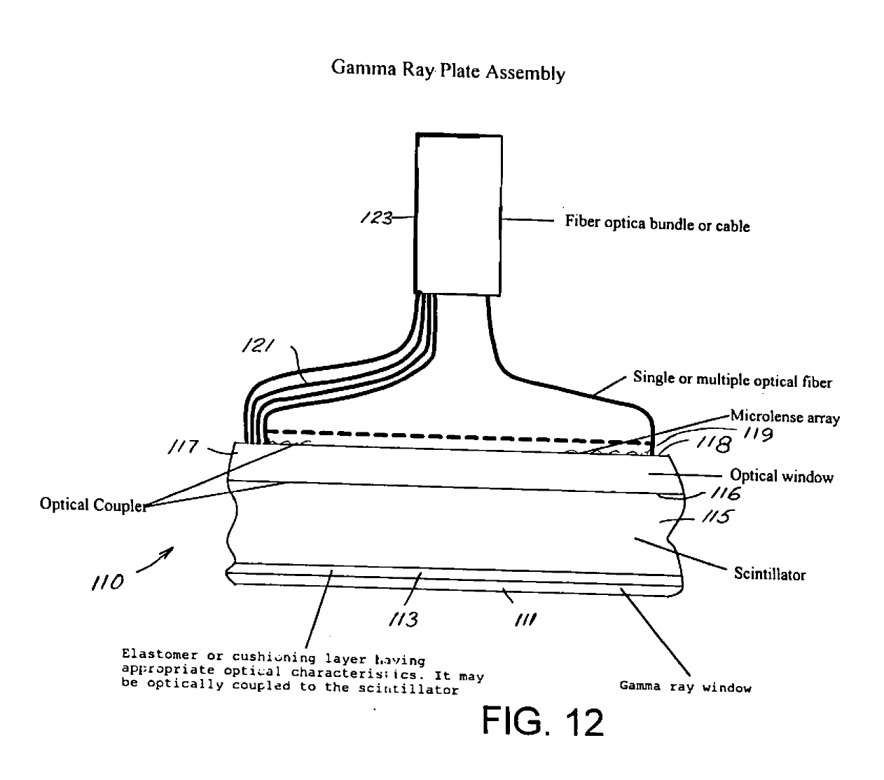

FIG. 12 shows a gamma ray plate assembly 110 with a gamma ray admitting window 111. An elastomer cushioning layer 113, which has appropriate optical characteristics, is connected between the gamma ray window and the scintillator 115. A glass plate optical window 117 overlies the scintillator. Optical coupler 116 seals the glass plate optical window 117 on the scintillator 115. An optical coupler 118 on top of the glass plate, which may be a micro lens array 119, connects many single or multiple optical fibers 121 to the glass plate. Photons from scintillator 115 pass through the optical couplers 116 and 118 and the glass plate 117. The singular or multiple optical fibers 121 and the fiber optic bundle or cable 123 transfer the photons to the photon-active device, for example a photomultiplier tube.

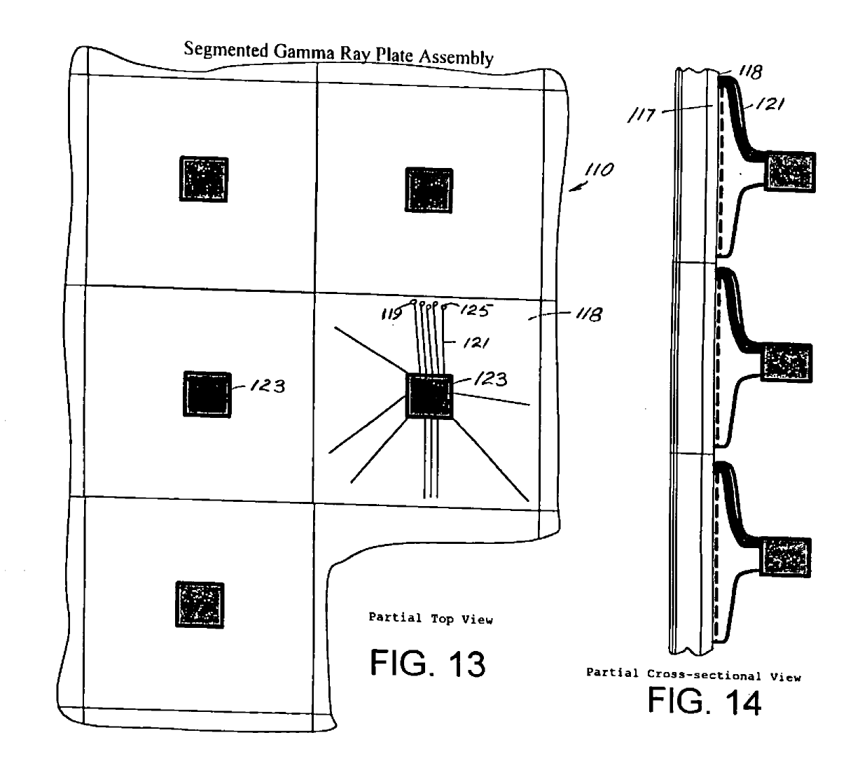

FIG. 13 is a partial top view of a segmented gamma ray plate assembly 110, such as shown in FIG. 12. Single or multiple optical fibers 121 have ends 125, which are connected to the optical coupler 118, which may be a micro lens array 119, to pass the photons created by the scintillator 155 through the fiber optic bundle 123.

FIG. 14 shows a partial cross-sectional view of the structure shown in FIG. 13. The dashed lines in FIGS. 14 and 12 represent multiple connections of the singular multiple optical fibers 121 to the optical coupler 118 atop the glass plate 117.

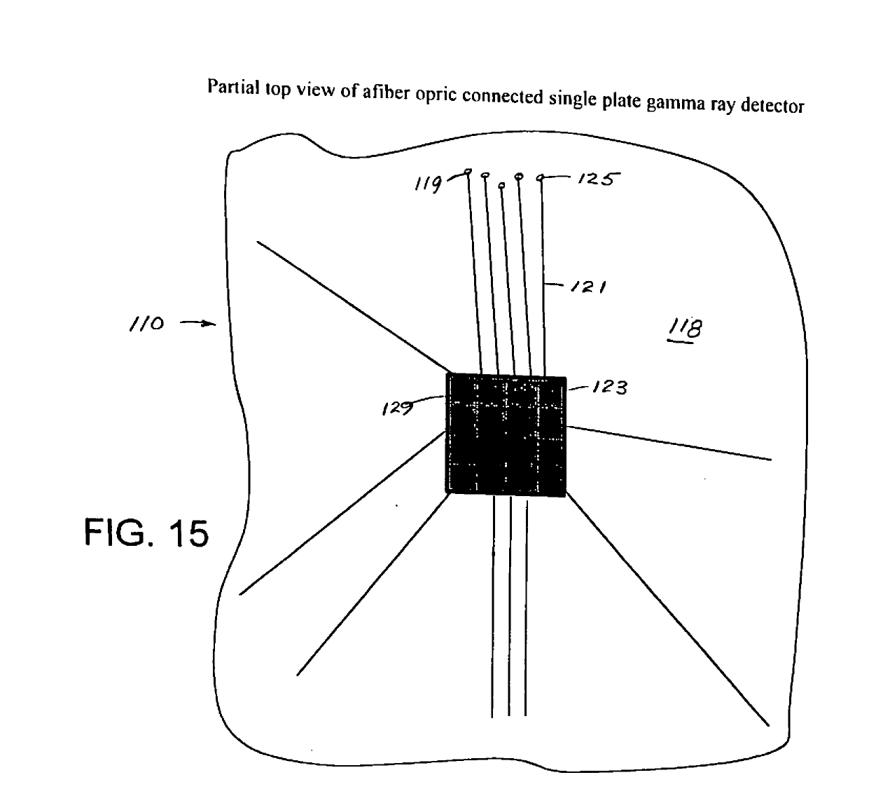

FIG. 15 shows a partial top view of a fiber optic connected single plate, gamma ray detector 110. The single or multiple optical fibers 121 have ends 125 connected to the optical coupler 118 or the multiple micro lenses 119 on top of the glass plate 117 above the scintillator 115. The fiber optic bundle or cable 123 shown in FIG. 15 has segmentation 129, which groups the single or multiple optical fibers 121 from distinct areas of the gamma camera ray detector.

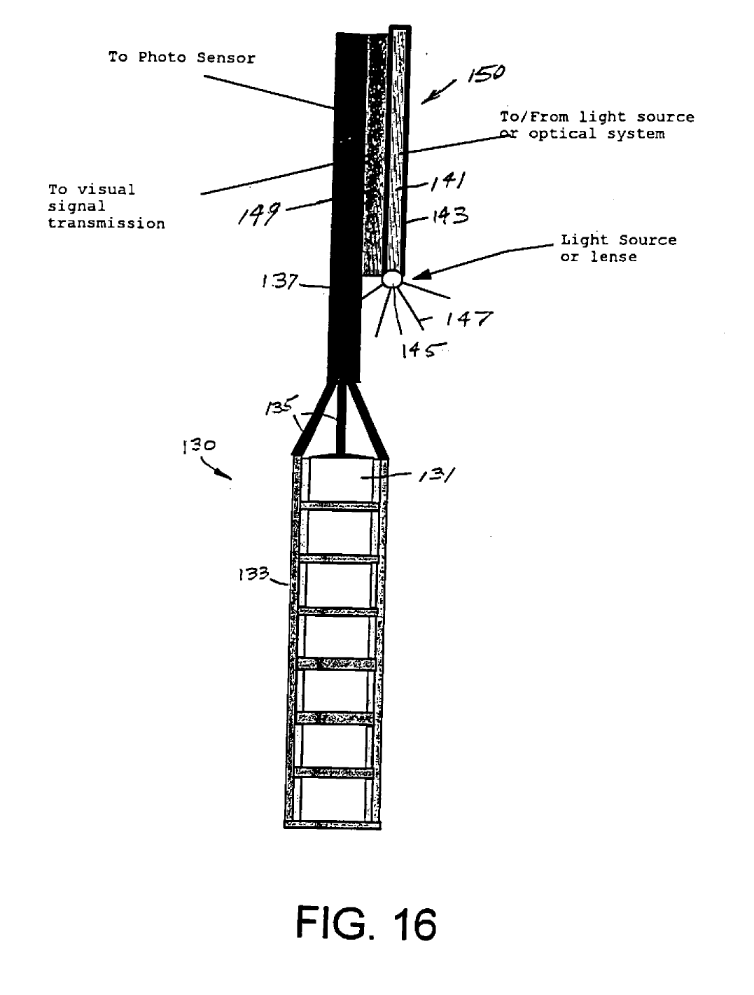

FIG. 16 shows a scintillator 130 made of plural scintillator crystals 131 in a flexible enclosure 133 which shields the scintillators from light. Each scintillator 131 is connected to one or more optical fibers 135 which are collected in a cable 137. Within or alongside cable 137 is an optical system 139. The optical viewing system 139 includes one or more light directing fibers 141 in a sheath 143 and a terminal lens 145 to direct light 147 on objects near the scintillator 130. One or more image fibers 149 are included in the assembly 150 to return to a viewer illuminated images of the scintillator and objects in areas near the scintillator 130. The same optical viewing system 130 may be used with any of the other scintillators described herein. For example the optical viewing system may be used with the scintillators described with reference to FIGS. 1 through 11. Similar optical viewing systems may be used with the flat plate scintillators described with reference to FIGS. 12 through 15 to see the area beneath the plate scintillator for insuring correct positioning and alignment.

While the invention has been described with reference to specific embodiments, modifications and variations of the invention may be constructed without departing from the scope of the invention, which is defined in the following claims.

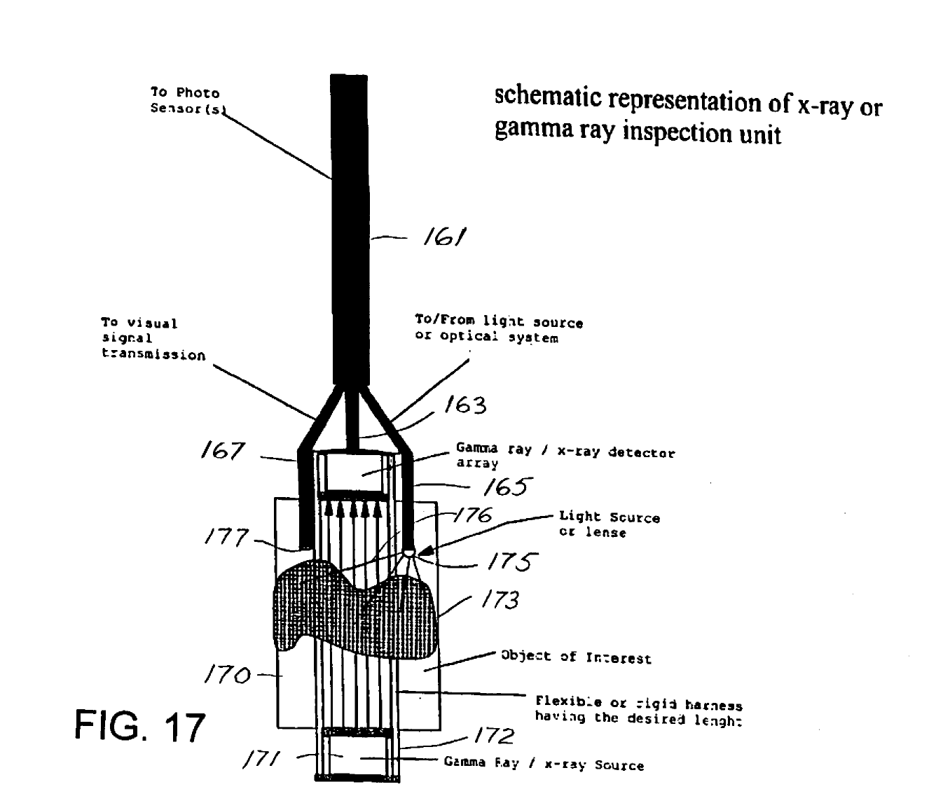

Referring to FIG. 17, the schematic representation of a x-ray or gamma ray inspection unit 160 is shown. The fiber optic cable 161 connects to photo sensors and carries the fiber 163, which receives photons to the photo detectors. Light guide fibers 165 are also contained in the cable, and light transmitting fibers 167 and are bound in the cable 161. A gamma ray, x-ray or particle detector array 169 is mounted in the inspection device. A gamma ray or x-ray source 171 is positioned opposite the gamma ray, x-ray or particle scintillator array 169. Rods 172 may connect the gamma ray and x-ray or particle scintillator array 169 and gamma ray, x-ray or particle source 171. The entire apparatus may be mounted vertically or horizontally on the table 170. An object 173 in which internal inspection is required is placed between the gamma ray, x-ray or particle source 171 and the gamma ray, x-ray or particle detector scintillator array 169. To record or observe the position of object 173 as it is being inspected a light source 175 or a lens, which directs light from the light conducting fibers 165 or, which powers a light source through wires in the cable projects light 176 on the object. Lens 177 connected to optical fibers 167 returns the image to the far end of the cable 161 where the image may be observed and recorded.

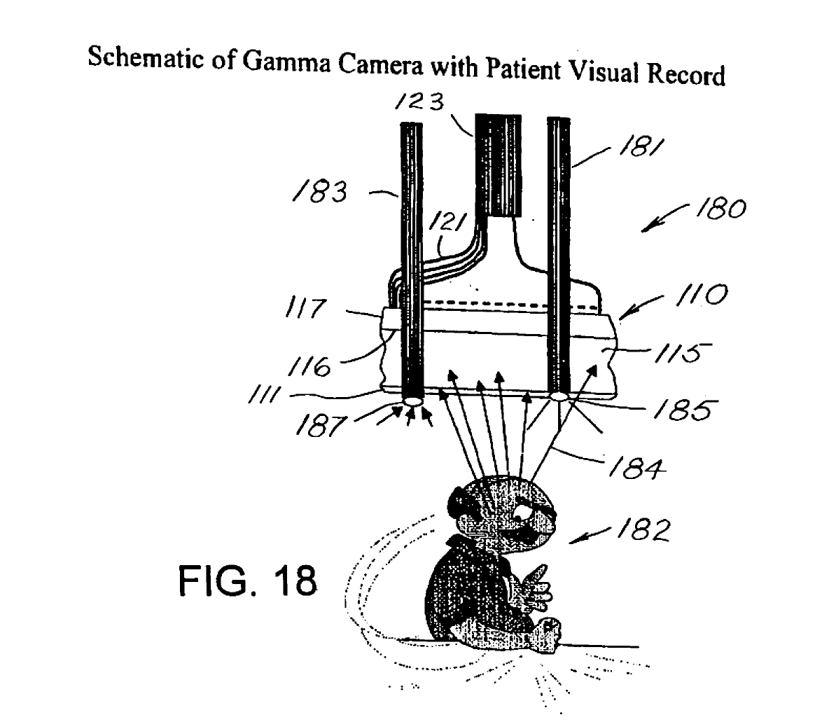

As shown in FIG. 18, a gamma camera with a patient's visual record capability is generally indicated by the numeral 180.

A patient 182 is positioned on a gamma camera bed or a chair next to a gamma camera assembly 110. The gamma camera assembly 110 through the gamma ray window 111 receives the gamma rays 184, which are produced by a substance in the subject's body, and the rays excite scintillation crystals within the scintillator 115. The optical cover 116 and optical window 117 pass the photons through optical fibers 121 and cable 123 to a detector array.

Optical fibers or wires 181 supply a lens or light source 185 to illuminate the subject 182 so that the particular portion of the subject being observed by the gamma camera plate can be recorded through the observation lens 187 and the optical fibers 183.

1. Fiber optic enhanced scintillator apparatus, comprising
a plurality of scintillators for producing photons upon being energized by particles, energy or rays, each of the plurality of scintillators further comprising a scintillator body made of scintillator material, surfaces on the body for directing photons toward a photon output, single or multiple light-conducting optical fibers having proximal and distal ends, and proximal ends of the fibers connected to the output for receiving photons from the output.

2-12. (canceled)

13. The apparatus of claim 1, wherein each scintillator body comprises a truncated conical shape having first and second radiused ends that are convex, concave or flat.

14. The apparatus of claim 13, further comprising first and second micro lens arrays optically coupled to the first and second radiused ends for focusing photons from each scintillator with the micro lenses in the arrays, and further comprising second single or multiple optical fibers connected near the second radiused end of each scintillator body, the second single and multiple optical fibers having a proximal end for receiving photons directed thereto by the micro lenses in the second array.

15. The apparatus of claim 1, further comprising a second output and first and second elastomeric optical coupler bodies connected to each scintillator body at opposite portions thereof for delivering photons from each scintillator body to the outputs, and for cushioning vibrations and impacts encountered by each scintillator.

16. The apparatus of claim 1, wherein each scintillator comprises a scintillator plate with an elastomer layer on one side optically coupled to each scintillator, a gamma ray window connected to the elastomer layer for admitting gamma rays into the scintillator plate, an optical coupler on the scintillator plate opposite the gamma ray window and the elastomer layer, and optical fibers having proximal ends connected to the optical coupler for conducting photons from the optical coupler through the optical fibers.

17. The apparatus of claim 16, wherein the optical fibers are arranged in optical bundles or cables.

18. The apparatus of claim 16, wherein the optical fibers comprise single or multiple optical fibers.

19. The apparatus of claim 16, further comprising a micro lens array connected to the optical coupler and to the proximal ends of the optical fibers for directing photons from each scintillator to the proximal ends of the optical fibers.

20. The apparatus of claim 16, wherein the scintillator plate is segmented in multiple segments, and the segments of the plate have optical couplers with proximal ends of optical fibers connected to the optical couplers on the segments of the plate, and wherein optical fibers connected to each segment are arranged in bundles for carrying photons from each segment through the optical fiber bundles to distant photon detectors at distal ends of the optical fibers.

21. The apparatus of claim 20, wherein the detectors are surrounded by electronic coolers.

22. The apparatus of claim 21, wherein the detectors are surrounded by magnetic field shielding.

23. The apparatus of claim 1, wherein each scintillator body comprises plural individual scintillator bodies and a holder connected to the scintillator bodies for holding the plural scintillator bodies in an array, and wherein the optical fibers comprise single or multiple optical fibers having proximal ends connected to the plural scintillator bodies.

24. The apparatus of claim 23, further comprising plural micro lenses connected to the plural scintillator bodies for coupling photons from the plural scintillator bodies to the proximal ends of the optical fibers.

25. The apparatus of claim 24, wherein the holder is flexible relative to each scintillator body.

26. The apparatus of claim 24, wherein the holder is resilient relative to each scintillator body.

27. The apparatus of claim 24, wherein the holder is elongated and flexible and the plural scintillator bodies are arranged axially in the holder.

28. The apparatus of claim 23, further comprising optical couplers provided on sides of the plural scintillator bodies for coupling the scintillator bodies to proximal ends of the optical fibers.

29. The apparatus of claim 28, wherein the plural optical bodies have square, polygonal, rectangular, oval or round cross-sections.

30. The apparatus of claim 23, wherein the plurality of scintillators comprises a plurality of independent scintillators, wherein the independent scintillators are angularly related to an axial direction of the holder, and wherein proximal ends of the optical fibers are connected to lateral edges of the angularly related scintillator bodies.

31. The apparatus of claim 30, wherein the plurality of independent scintillators have square, polygonal, rectangular, oval, round cross-sections, or combination thereof.

32. The apparatus of claim 30, wherein the angularly related plural independent scintillators have optical connectors at opposite side edges for connecting to first and second groups of optical fibers at opposite side edges of the plural bodies.

33. The apparatus of claim 30, further comprising bundling the optical fibers connected to the plural bodies, connecting optical fibers at first sides of the plural angularly related independent scintillators to a first fiber optic cable, and connecting optical fibers at opposite sides of the plural angularly related independent scintillators to a second fiber optic cable.

34-80. (canceled)

81. A detector apparatus comprising a scintillation crystal assembly, optical fibers connected to the crystal assembly, and further comprising an optical viewing portion connected to the optical fibers for allowing an operator to view the assembly and adjacent objects from a distance, the optical viewing portion having a light source at one or both ends and employing micro lenses, lenses, shaped light guides, or other optical components connected to the optical fibers for providing sharp images of the objects being viewed, the viewing portion providing observation and shape and size measurements or control functions.

82. Scintillation detection and viewing apparatus comprising optical fibers having proximal and distal ends, a scintillator connected to the distal ends, detectors connected to the proximal ends, and light sources and viewers connected to the proximal ends for illuminating objects at the distal ends and viewing images of the objects at the distal ends.

83. The apparatus of claim 82, wherein the scintillation detection and viewing apparatus is a well logging device.

84. The apparatus of claim 82, wherein the scintillation detection and viewing apparatus is a gamma camera device where one remotely views the patient being examined in real time, or the signal is recorded while the gamma ray examination takes place.

85. The apparatus of claim 82, wherein the scintillation detection and viewing apparatus is a remote gamma ray or other high energy ray or particle measuring tool having optical viewing capabilities for using the combined tool, and a weld inspection unit for examining weld quality and visual inspection before, during and after the scintillation detection.

86. The apparatus of claim 82, wherein the scintillation detection and viewing apparatus is a remote gamma ray, X-ray, high energy particle tool having visual inspection used in radioactive storage tanks applications, automotive industry applications, other industrial tools for measurement of high energy rays or particles, or measurements using such high energy rays or particles for structural integrity, density uniformities, and similar applications.

87. The apparatus of claim 82, wherein the scintillation detection and viewing apparatus comprises a combination of light source, X-ray source, X-ray detector for visual inspection.

88-132. (canceled)
